(19) United States
(12) Patent Application Publication
(10) Pub. No.: US 2011/0233912 A1
(43) Pub. Date: Sep. 29, 2011

(54) Portfolio

(75) Inventor: Kevin C. Reising, Keego Harbor, MI (US)

(73) Assignee: CRYSTAL PROFILE INDUSTRIES, LLC, Keego Harbor, MI (US)

(21) Appl. No.: 12/729,641

(22) Filed: Mar. 23, 2010

(51) Int. Cl. B42D 1/00; B42D 3/12; B42D 19/00

(52) U.S. Cl. 281/20; 281/21.1; 281/30; 281/44

(57) ABSTRACT

A portfolio including a first cover to carry a product, and a second cover coupled to the first cover. The portfolio also may include one or more novel arrangements of features to protect the product if the portfolio is dropped, render the portfolio suitable for use by right-handed and left-handed users alike, facilitate releasable fastening of the product to the portfolio, and/or protect the product in a closed position of the portfolio.

### TECHNICAL FIELD

This disclosure relates generally to portfolios.

### BACKGROUND

Some portfolios are configured to carry writing pads on interior surfaces of rear covers on right hand sides of the portfolios when open. Thus, such portfolios tend to be well suited for right-handed individuals. But such portfolios are not well suited for use by left-handed individuals, or by other individuals who otherwise desire to have a writing pad disposed on a left side of an open portfolio.

Some protective cases for electronic devices are configured to at least partially cover peripheral edges of the electronic devices with a thin layer of protective material like leather, plastic, or metal. But the thin layer of protective material may not protect the electronic device if dropped on its peripheral edges. Also, such protective cases may not sufficiently retain electronic devices, wherein the devices may become dislodged from their respective cases if dropped.

### SUMMARY

A portfolio including a first cover to carry a product, and a second cover coupled to the first cover. The portfolio also may include one or more novel arrangements of features to protect the product if the portfolio is dropped, render the portfolio suitable for use by right-handed and left-handed users alike, facilitate releasable fastening of the product to the portfolio, and/or protect the product in a closed position of the portfolio.

### BRIEF DESCRIPTION OF THE DRAWINGS

Features and advantages of one or more of the disclosed embodiments of this disclosure will be apparent to those of ordinary skill in the art from the following detailed description of exemplary embodiments and the claims, with reference to the accompanying drawings in which:

FIG. 1 is a plan view of an exemplary embodiment of a portfolio, illustrated in an open position;

FIG. 2 is a top view of the portfolio of FIG. 1;

FIG. 3 is a bottom view of the portfolio of FIG. 1;

FIG. 4 is a left side view of the portfolio of FIG. 1;

FIG. 5 is a right side view of the portfolio of FIG. 1; and

FIG. 6 is a plan view of the portfolio of FIG. 1, illustrated in a position rotated 180 degrees from that shown in FIG. 1.

### DETAILED DESCRIPTION

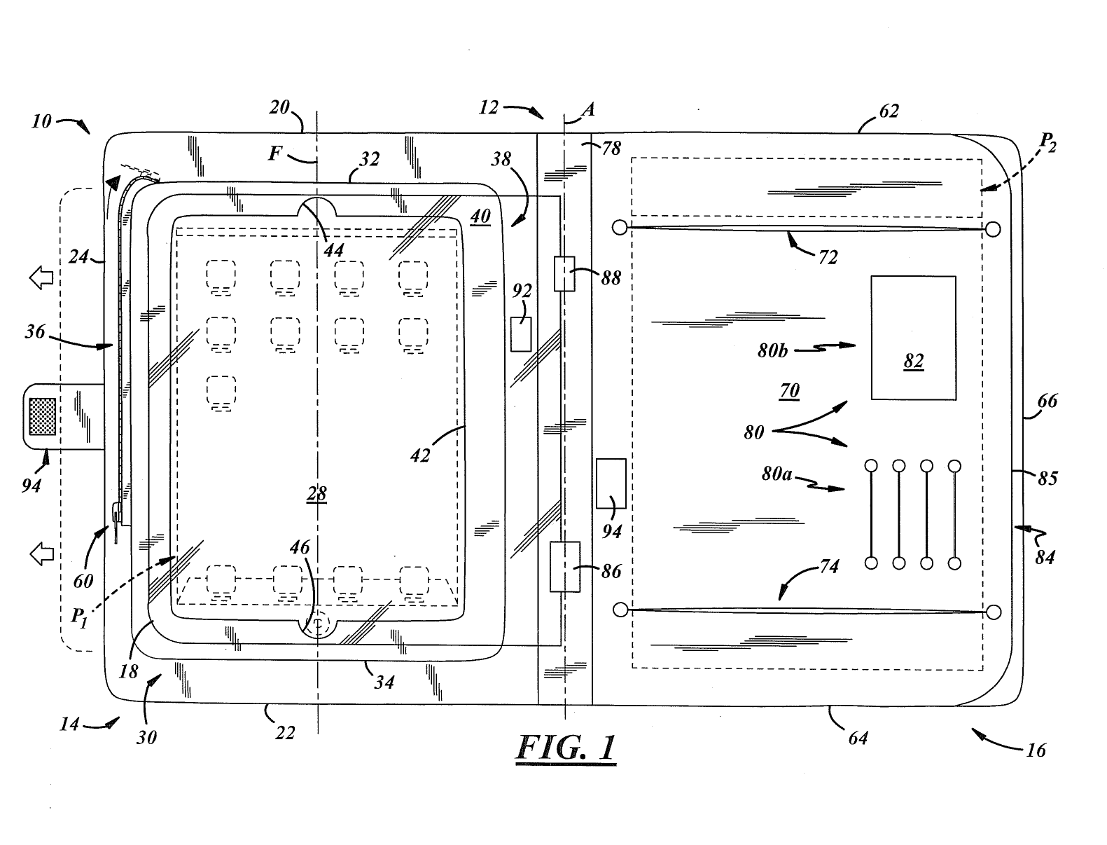

Referring to the drawings, FIG. 1 illustrates an exemplary embodiment of a portfolio 10 that is shown in an open position and that may include a spine 12 extending in a generally longitudinal direction along a longitudinal axis A of the portfolio 10. As used herein, directional words such as front, rear, top, bottom, upper, lower, axial, lateral, longitudinal, vertical, horizontal, transverse, and/or the like are employed by way of description and not necessarily of limitation. With reference to FIG. 1, the portfolio 10 also includes a first cover 14 and a second cover 16 coupled to the first cover 14 in any suitable manner. In one embodiment, the covers 14, 16 may be coupled directly to one another in any suitable manner. In the illustrated embodiment, the covers 14, 16 may be coupled to one another via the spine 12. For instance, the first cover 14 may extend from the spine 12 in a first lateral direction, and is configured to carry a product P1. As used herein, the terms longitudinal and lateral do not necessarily define strict perpendicularity therebetween. Similarly, the second cover 16 may extend from the spine 12 in a second lateral direction, and may be configured to carry another product P2. The portfolio 10 also may include a protective sheet 18 that may be carried by the spine 12 or by a portion of the first cover 14. As will be described in greater detail below, the portfolio 10 may include novel arrangements of features that protect the first product P1 if the portfolio 10 is dropped, that render the portfolio 10 suitable for use by right-handed and left-handed users alike, that facilitate releasable fastening of the first product P1 to the portfolio 10, and/or that protect the first product P1 in a closed position of the portfolio 10.

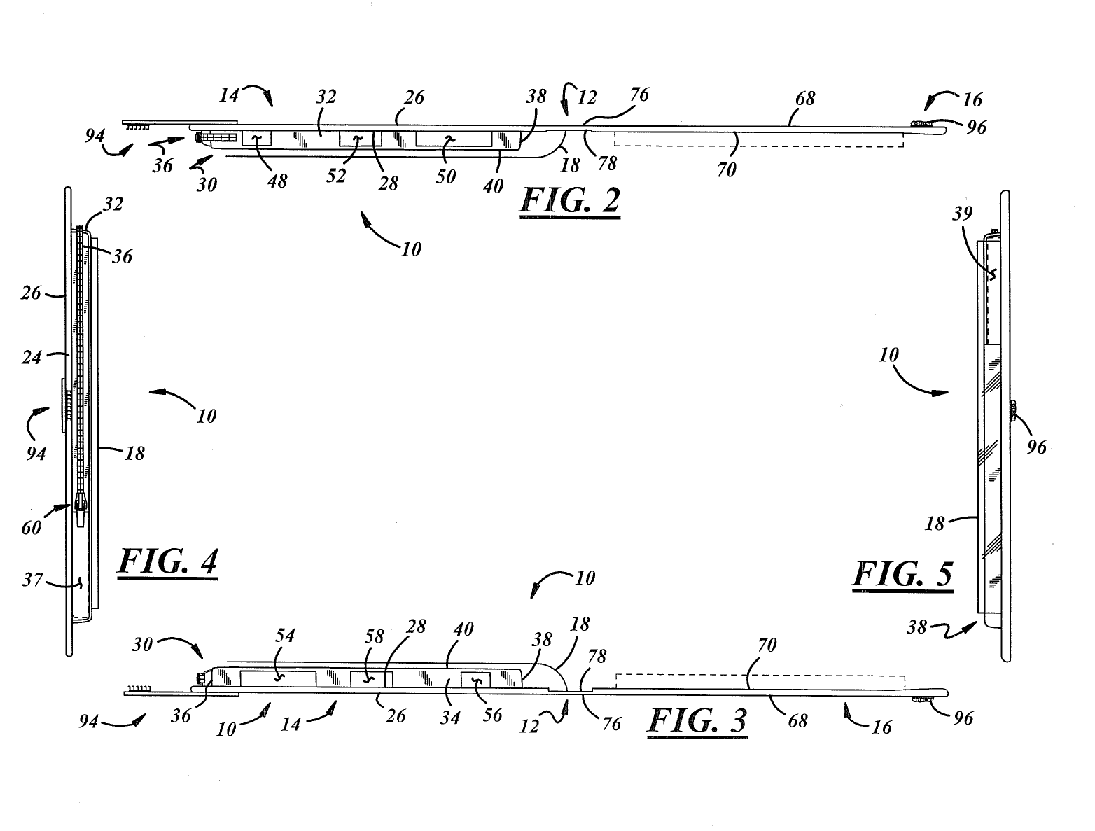

The first cover 14 may carry the first product P1 in any suitable manner, and the first product P1 may include an electronic device, for example, an iPad brand computing device from Apple Computer of Cupertino, Calif., or a Kindle brand reading device available from Amazon of Seattle, Wash., or any other suitable device. The first cover 14 may include a first pair of longitudinally opposed peripheral edges 20, 22, and a first laterally outboard peripheral edge 24 disposed between the first pair of longitudinally opposed peripheral edges 20, 22. The first cover 14 also may include an exterior including a first exterior surface 26 (FIGS. 2-4), an interior including a first interior surface 28 and a first product attachment feature, which may be a frame 30 to carry the first product P1. Although not separately shown, the first cover 14 may include one or more reinforcement members like a plastic or paper board, or the like, one or more pads, and an outer skin or covering material.

Referring to FIGS. 1-3, the frame 30 may have walls that may extend in a direction away from the first interior surface 28. The walls may include first and second frame walls 32, 34 that may be longitudinally opposed and may extend in a generally lateral direction. The walls also may include third and fourth frame walls 36, 38 that may be laterally opposed, may extend in a generally longitudinal direction orthogonally with respect to the first and second walls 32, 34.

With reference to FIG. 1, the frame 30 also may have a generally planar lip 40 that may extend between two or more walls of the frame 30. The lip 40 may be at least partially defined by a product access opening 42 that may be generally rectangular, or of any other suitable shape. The opening 42 may be at least partially defined by longitudinally opposed reliefs 44, 46 in the generally planar lip. The reliefs 44, 46 may be scallop-shaped as shown or of any other suitable shape, and may accommodate a feature of the product P1 held by the frame, for instance, a control button or the like. Also, the reliefs 44, 46 may be diagonally opposed from one another across a longitudinal axis F of the frame 30. In the illustrated embodiment, the reliefs 44, 46 are longitudinally aligned wherein the diagonal angle therebetween is zero. But in other embodiments, the reliefs 44, 46 may be diagonally opposed at an angle greater than zero, for example, at opposed lateral sides of the frame 30.

The walls 32-36 and/or the lip 40 may be constructed of one or more layers of material that may be the same as or different from the material(s) of the covers 14, 16. In one embodiment, the walls 32-36 and/or the lip 40 may include any suitable type of padding to protect the product P1. The padding may be exposed or may be disposed between inner and outer layers of other material.

The first, second, and/or third frame walls 32, 34, 36 may be spaced from the peripheral edges 20, 22, 24 of the front cover 14 to define protective margins therebetween. Similarly, the fourth frame wall 38 may be spaced from the spine 12 to define a protective margin therebetween. Accordingly, if the portfolio 10 is ever dropped, the protective margins will provide protection for outboard peripheral edges of the product P1 additional to that of the protection provided by the frame walls 32, 34, 36, 38 and lip 40.

Referring now to FIGS. 2 and 3, in general, one or more of the frame walls 32, 34, 36, 38 may have one or more apertures extending therethrough, for example, to permit access to features of the product P1 like ports, buttons, or the like. The apertures may be provided in any suitable quantity, size, and spacing. More specifically, in an example embodiment, the first frame wall 32 may have one or more apertures, which may include a first opening or aperture 48 relatively proximate the third wall 36, a second aperture 50 relatively proximate the fourth wall 38, and a third aperture 52 therebetween. Similarly, the second frame wall 34 may have one or more apertures, which may include a fourth aperture 54 relatively proximate the fourth wall 38, a fifth aperture 56 relatively proximate the third wall 36, and a sixth aperture 58 therebetween.

Two or more of the apertures may be diagonally opposed from one another, for example, across the longitudinal axis F of the frame 30. For example, the fifth aperture 56 may be identical to the first aperture 48 and may be disposed diagonally therefrom across the longitudinal axis F. Likewise, the fourth aperture 54 may be identical to the second aperture 50 and may be disposed diagonally therefrom across the longitudinal axis F. Similarly, the sixth aperture 58 may be identical to the third aperture 52 and may be disposed diagonally respectfully therefrom. In the latter example, the third and sixth apertures 52, 58 are basically centered on the axis F and, thus, the diagonal angle therebetween is zero. The diagonally disposed apertures, like the lip reliefs, may enable the product P1 to be held by the frame 30 in longitudinally opposed orientations to facilitate use of the portfolio 10 by right-handed and left-handed users alike.

Referring now to FIG. 4, the third frame wall 36 may be disposed adjacent to the first laterally outboard peripheral edge 24 and may extend between the first and second frame walls 32, 34 but not necessarily the entire distance therebetween. For example, as shown, the wall 36 may extend short of the second frame wall 34 to define a gap or aperture 37. The third frame wall 36 may include or may consist of a releasable fastener 60, for example, to facilitate releasable fastening of the product P1 within the frame 30. The first frame wall 32 may also partially include at least a portion of the releasable fastener 60 such that the releasable fastener 60 extends over or constitutes parts of the first and third frame walls 32, 36. The releasable fastener 60 may include a zipper, as shown, a hook-and-loop fastener, or any other suitable releasable fastener. As shown in FIG. 1, the releasable fastener 60 may be unzipped or otherwise released to allow removal of the product P. The releasable fastener 60 also or instead may include one or more buttons, snaps, magnets, or the like.

The aperture 37 of the third frame wall 36 may be provided for access to or projection of a port or the like of the product P1. Likewise, as shown in FIG. 5, the fourth frame wall 38 may include an aperture 39 for the same port or the like of the product P1 when the product P1 is carried in an opposed longitudinal direction by the frame 30. Accordingly, the apertures 37, 39 are diagonally opposed from one another, for example, across a lateral axis of the frame 30 that is perpendicular to and bisecting the longitudinal axis F of the frame 30.

Referring to FIG. 1, the protective sheet 18 may be coupled to any portion of the portfolio 10 in any suitable manner so as to overlay the frame 30 in a closed position of the portfolio 10 and thereby protect the product P1, for example, from abrasion by the second cover 16 or the second product P2 carried by the second cover 16. The protective sheet 18 may be relatively flexible compared to the covers 14, 16 and may be composed of any material like silk, paper, paper vellum, plastic, or any other suitable material. In the illustrated embodiment, the protective sheet 18 is transparent, but instead may be translucent or opaque. The protective sheet 18 may be sewn, adhered, releasably fastened, or secured in any other suitable manner to the front cover 14 or the spine 12. In the illustrated embodiment, the sheet 18 is coupled to the spine 12, but in other embodiments, the sheet 18 may be coupled to any margin between the frame 30 and the first peripheral edge 20 of the first cover 14, or to the frame 30 itself for instance on the planar surface 40 and/or on any of the walls 32, 34, 36, 38. Also, the sheet 18 may be of any suitable shape and size. For instance, the sheet 18 may be generally rectangular like the frame 30, and may be about the same size as the laterally and longitudinally outer periphery of the frame 30.

The second cover 16 may carry the second product P2 in any suitable manner, and the second product P2 may include a memo pad, or any other suitable article or device. The second cover 16 may include a second pair of longitudinally opposed peripheral edges 62, 64, and a second laterally outboard peripheral edge 66 disposed between the second longitudinally opposed peripheral edges 62, 64. Although not separately shown, like the first cover 14, the second cover 16 may include one or more reinforcement members like a plastic or paper board, or the like, one or more pads, and an outer skin or covering material. The outer skin or covering material may extend over both the first and second covers 14, 16 and the spine 12.

The second cover 16 also may include a second exterior surface 68, a second interior surface 70, and one or more second product attachment features. For example, a right-handed product attachment feature 72 may be disposed proximate one of the second longitudinally opposed peripheral edges 62, and/or a left-handed product attachment feature 74 may be disposed proximate the other of the second longitudinally opposed peripheral edges 64. The second product attachment features 70, 72 may be longitudinally opposed slits or slots in the second interior surface 66, for example, to accommodate insertion of a backing board of a memo pad.

The second cover 16 also may include one or more pockets 80 having openings extending in a generally longitudinal direction and open toward the spine 12. For example, the pockets 80 may be include one or more slits or slots 80a to hold or carry business cards, and/or covered pockets 80b. The covered pockets 80b may have covers 82, which may be one or more layers of material(s) attached to the interior surface 70 of the second cover 16. In any case, the pockets 80 retain items therein in a manner that enables use of the portfolio 10 in either a right-handed or left-handed manner wherein the items do not fall out if the portfolio 10 is rotated 180 degrees, inverted upside-down, or the like. If the items fall out of the pockets 80, they will tend to fall toward and be caught by the spine 12.

The second cover 16 further may include one or more laterally peripheral pockets 84 having one or peripheral edges 85, for example, to carry one or more documents or other items therein. Such a pocket 84 may be constructed in any suitable manner. For instance, a layer of material that defines the interior surface 70 may be sewn, adhered, thermoformed, or otherwise attached to an underlying layer of cover material and/or reinforcement member (not shown) proximate the edges 62, 64 and left unattached along the edge 66 to define an opening between the edges 66, 85 into which items may be inserted and carried.

Referring to FIGS. 1-3, the spine 12 may be of any suitable construction to couple the covers 14, 16 together in a foldable manner, between at least a closed position and the illustrated open position. In the illustrated embodiment, the spine 12 may include exterior and interior surfaces 76, 78 and may include the same covering material as the first and second covers 14, 16. The spine 12 may be relatively flexible compared to the covers 14, 16 to facilitate opening and closing of the portfolio 10. In another embodiment, the spine 12 may include any suitable type(s) of hinge(s), or any other suitable device(s).

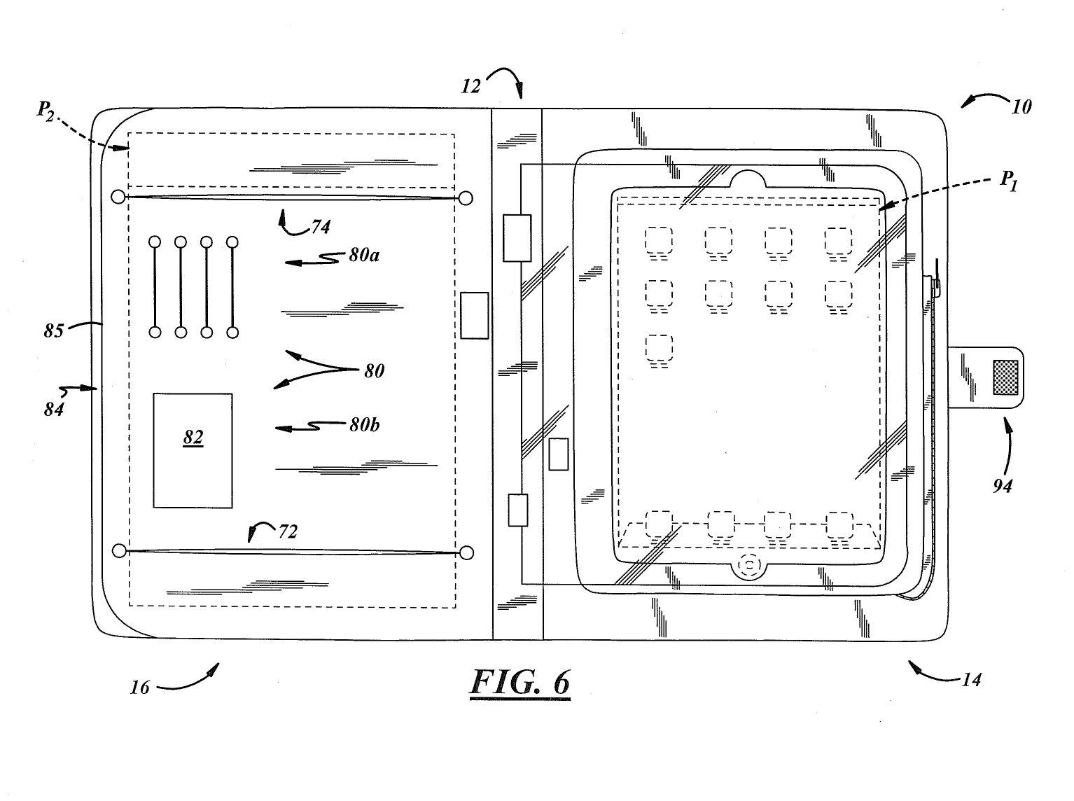

Referring to FIG. 1, the portfolio 10 also may include one or more writing instrument holders for one or more pens, styli, or the like (shown only in FIGS. 1 and 6). For example, the portfolio 10 may include collinear holders including a pen holder 86 and a stylus holder 88 longitudinally spaced therefrom. The collinear holders 86, 88 may be carried by the spine 12 as shown, or instead may be carried by the covers 14, 16. In another example, the portfolio 10 may include laterally spaced holders including a pen holder 90 and a stylus holder 92. The holders 90, 92 may be carried on the covers 14, 16 adjacent the spine 12 and longitudinally aligned or overlapping as shown, or may be longitudinally staggered or spaced apart. The stylus holders 88, 92 may be relatively smaller than the pen holders 86, 90. As used herein, the term pen includes pen, pencil, marker, or any other suitable type of writing instrument. The holders 86-92 may be constructed in any suitable manner, for example, from loops of material sewn, adhered, or otherwise attached to the portfolio 10. In another embodiment, the holders 86-92 may be hooks, cradles, or any other suitable elements.

The portfolio 10 further may include fastening elements 94, 96 to couple the laterally outer portions of the covers 14, 16 to one another. For example, the fastening elements 94, 96 may include straps, snaps, buttons, hook-and-loop fasteners, magnets, zippers, and/or any other suitable types of fasteners.

Referring to FIG. 6, the portfolio 10 is illustrated in an orientation that is rotated 180 degrees with respect to the orientation shown in FIG. 1. The orientation of the portfolio in FIG. 6 may be referred to a left-handed orientation. This orientation may be particularly suitable for use with users who are left-handed so they can, for example, more comfortably write on a memo pad that may be the second product P2. For example, a backing board of the memo pad may be inserted into the second product attachment feature 74 which may be a slot in the pocket 84 or in another covering material of the second cover 16.

With reference to FIG. 1, in contrast, the orientation of the portfolio 10 in FIG. 1 may be referred to a right-handed orientation. This orientation may be particularly suitable for use with users who are right-handed so they can, for example, more comfortably write on a memo pad that may be the second product P2. For example, a backing board of the memo pad may be inserted into the first product attachment feature 72 which may be another slot in the pocket 84 or in another covering material of the second cover 16.

In a further embodiment, instead of the frame 30, the first product attachment feature may be a clip, cradle, or any other suitable attachment feature that can carry the product P1 in longitudinally opposed orientations.

In general, the portfolio 10 may be manufactured according to any suitable techniques known to those skilled in the art. For example, the components may be cut from sheets, molded, pressed, stamped, and/or the like. Also, the portfolio 10 may be assembled according to any suitable known techniques, including sewing, adhering, thermoforming, and/or the like. Likewise, any suitable materials can be used in making the components, such as leather, polymeric materials, paper materials, metals, and/or the like.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “the” are intended to mean that there are one or more of the elements. Other terms are to be construed using their broadest reasonable meaning unless they are used in a context that requires a different interpretation.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

1. A portfolio comprising:
a first cover extending in a first lateral direction when the portfolio is open;
a second cover coupled to the first cover and extending in a second lateral direction when the portfolio is open; and
wherein the first cover includes:
a first pair of longitudinally opposed peripheral edges,
a first laterally outboard peripheral edge disposed between the first pair of longitudinally opposed peripheral edges,
a first exterior surface,
a first interior surface, and
a frame to carry a product, and having walls extending in a direction away from the first interior surface.

2. The portfolio of claim 1, wherein the frame walls are spaced from the peripheral edges to define a protective margin therebetween.

3. The portfolio of claim 1, wherein the frame walls include:
a first wall having at least one first aperture therethrough, and
a second wall longitudinally opposed from the first wall and having at least one second aperture therethrough disposed diagonally from the at least one first aperture.

4. The portfolio of claim 1, wherein the frame includes a generally planar lip extending between the walls of the frame, wherein the generally planar lip is at least partially defined by a generally rectangular opening.

5. The portfolio of claim 4, wherein the opening is at least partially defined by longitudinally opposed reliefs in the generally planar lip.

6. The portfolio of claim 1, wherein the frame walls include:
a first wall; and
a second wall longitudinally opposed from the first wall;
a third wall adjacent the first laterally outboard peripheral edge, extending between the first and second walls, and at least partially including a releasable fastener extending from the first wall toward but stopping short of the second wall so as to define a third aperture; and
a fourth wall laterally opposed from the third wall, extending between the first and second walls, and including a fourth aperture diagonally opposed from the third aperture.

7. The portfolio of claim 6, wherein the first wall of the frame also partially includes at least a portion of the releasable fastener such that the releasable fastener extends over parts of the first and third walls of the frame.

8. The portfolio of claim 1, wherein the releasable fastener includes a zipper.

9. The portfolio of claim 1, further comprising:
a spine extending in a longitudinal direction and coupling the covers together; and
a protective sheet coupled to at least one of the spine or the first cover and configured to overlay the frame in a closed position of the portfolio.

10. The portfolio of claim 1,
wherein the second cover includes:
a second pair of longitudinally opposed peripheral edges,
a second laterally outboard peripheral edge disposed between the second longitudinally opposed peripheral edges,
a second exterior surface,
a second interior surface,
a right-handed product attachment feature disposed proximate one of the second longitudinally opposed peripheral edges, and
a left-handed product attachment feature disposed proximate the other of the second longitudinally opposed peripheral edges.

11. The portfolio of claim 1, further comprising at least one pair of writing instrument holders that are at least one of: collinear and longitudinally spaced apart between the first and second covers, or longitudinally and laterally spaced apart on the first and second covers.

12. A portfolio comprising:
a first cover including a first exterior and a first interior having a first product attachment feature to carry a first product in at least first and second longitudinal orientations of the first product; and
a second cover including a second exterior and a second interior having at least one second product attachment feature to carry a second product in at least first and second longitudinal orientations of the second product,
wherein the portfolio is configured for right-handed and left-handed users.

13. The portfolio of claim 12, wherein the first product attachment feature is a frame having opposed orthogonal walls and a generally planar lip extending therebetween.

14. The portfolio of claim 12, wherein the at least one second product attachment feature includes a right-handed memo pad attachment feature disposed proximate a first longitudinal edge of the second cover and a left-handed memo pad attachment feature disposed proximate a second longitudinal edge of the second cover and disposed longitudinally opposite of the first longitudinal edge.

15. The portfolio of claim 14, wherein the memo pad attachment features include generally laterally extending slots in the second cover.

16. A portfolio for right-handed and left-handed users, comprising:
a first cover;
a second cover coupled to the first cover; and
wherein the first cover includes an exterior, and an interior including a frame to carry a product, wherein the frame includes longitudinally opposed walls extending away from an interior surface of the first cover and having diagonally opposed apertures therethrough.

17. The portfolio of claim 16, wherein the frame also includes a generally planar lip extending between said walls and defining a generally rectangular opening and longitudinally opposed reliefs.

18. A portfolio comprising:
a first cover;
a second cover coupled to the first cover; and
wherein the first cover includes an exterior, and an interior including a frame to carry a product, wherein the frame includes longitudinally opposed walls extending away from an interior surface of the first cover, at least one sidewall extending away from the interior surface of the first cover, and a releasable fastener extending over at least a portion of the at least one sidewall.

19. The portfolio of claim 18, wherein the releasable fastener also extends over at least a portion of one of the longitudinally opposed walls.

20. The portfolio of claim 18, wherein the releasable fastener includes a zipper.
